(19) United States
(12) Patent Application Publication
(10) Pub. No.: US 2022/0410625 A1
(43) Pub. Date: Dec. 29, 2022

(54) ASSEMBLY COMPRISING AN ADAPTABLE SUPPORT STRUCTURE

(71) Applicant: COMPAGNIE GENERALE DES ETABLISSEMENTS MICHELIN, Clermont-Ferrand (FR)

(72) Inventors: JEREMY GUILLAUMAIN, Clermont-Ferrand (FR); MAGALY BROUSSEAU, Clermont-Ferrand (FR); BASTIEN LIMOZIN, Clermont-Ferrand (FR); SEBASTIEN RIGO, Clermont-Ferrand (FR)

(21) Appl. No.: 17/780,150

(22) PCT Filed: Nov. 26, 2020
(86) PCT No.: PCT/FR2020/052192

§ 371 Date: May 26, 2022

(30) Foreign Application Priority Data
Nov. 29, 2019 (FR) 1913487

(51) Int. Cl. B60C 1/00; B60C 9/10; B29D 30/06

(52) U.S. Cl. CPC B60C 1/0008; B60C 9/10; B29D 30/0681; B29D 2030/0683

(57) ABSTRACT

The invention relates to an assembly for a tyre comprising a first fabric, a second fabric and a load-bearing structure comprising filamentary load-bearing elements made of heat-shrinkable textile material connecting the first fabric to the second fabric, the load-bearing filamentary elements exhibit a thermal contraction CT, measured after 2 min at 185° C., greater than or equal to 5%.

### TECHNICAL FIELD OF THE INVENTION

The subject of the invention is an assembly and a rubber article, in particular a pneumatic tyre, comprising this assembly.

The invention relates in particular to the field of pneumatic tyres intended to be fitted to vehicles. The pneumatic tyre is preferably designed for passenger vehicles but can be used on any other type of vehicle, such as two-wheeled vehicles, heavy-duty vehicles, agricultural vehicles, construction plant vehicles or aircraft or, more generally, on any rolling device.

### PRIOR ART

In the following text, and by convention, the circumferential direction XX′, axial direction YY′ and radial direction ZZ′ refer to a direction tangential to the tread surface of the pneumatic tyre in the direction of rotation of the tyre, to a direction parallel to the axis of rotation of the tyre, and to a direction perpendicular to the axis of rotation of the pneumatic tyre, respectively. “Radially inner” and “radially outer” mean “closer to the axis of rotation of the pneumatic tyre” and “further away from the axis of rotation of the pneumatic tyre”, respectively. “Axially inner” and “axially outer” mean “closer to the equatorial plane of the pneumatic tyre” and “further away from the equatorial plane of the pneumatic tyre”, respectively, the equatorial plane XZ of the pneumatic tyre being the plane passing through the middle of the tread surface of the pneumatic tyre and perpendicular to the axis of rotation of the pneumatic tyre.

In general, a pneumatic tyre comprises a crown having two axial ends that are each extended radially towards the inside by a sidewall and then by a bead intended to come into contact with a rim, the assembly delimiting a toric interior cavity. More specifically, the crown comprises, radially from the outside towards the inside, a tread, intended to come into contact with the ground via a tread surface, a crown reinforcement, and a carcass reinforcement portion which are intended to reinforce the tyre. The carcass reinforcement connects the two sidewalls together by extending in a radially inner portion of the crown and is anchored, in each bead, to a circumferential reinforcing element, usually of the bead wire type.

At any point on its tread surface, which is intended to come into contact with the ground, the pneumatic tyre has a double curvature: a circumferential curvature and a meridian curvature. A circumferential curvature means a curvature in a circumferential plane, defined by the circumferential direction and the radial direction. A meridian curvature means a curvature in a meridian or radial plane, defined by the axial direction and the radial direction.

It is known that the flattening of the pneumatic tyre on horizontal ground, in a circumferential plane and in a meridian plane, is conditioned by the values of the circumferential and meridian radii of curvature, respectively, at the points of the tread surface that are positioned at the limits of the contact patch in which the tyre is in contact with the ground. This flattening is all the easier the larger these radii of curvature are, that is to say when the curvatures are small, since the curvature at any one point, in the mathematical sense, is the inverse of the radius of curvature. It is also known that the flattening of the pneumatic tyre has an impact on the performance of the tyre, in particular rolling resistance, grip, wear and noise.

Consequently, those skilled in the art, specializing in pneumatic tyres, seeking to obtain a good compromise between the expected performance of the pneumatic tyre, such as wear, grip, endurance, rolling resistance and noise, this list not being exhaustive, have developed alternative solutions to conventional pneumatic tyres in order to optimize the flattening thereof.

A conventional pneumatic tyre of the prior art generally has a high meridian curvature, that is to say a small meridian radius of curvature, at the axial ends of the tread, known as shoulders, when the pneumatic tyre, mounted on its mounting rim and inflated to its recommended use pressure, is subjected to its nominal load. The mounting rim, the operating pressure and the nominal load are defined by standards, such as the standards of the European Tyre and Rim Technical Organisation (ETRTO), for example.

Pneumatic tyres allowing improved flattening have been proposed. For example, documents WO2018/130782 and WO2018/130783 describe a pneumatic tyre whose flattening is facilitated, comprising a first and a second fabric extending in a first general direction, connected by a supporting structure comprising load-bearing filamentary elements connecting the first fabric to the second fabric, each load-bearing filamentary element comprising at least one load-bearing filamentary portion extending between the first and the second fabric, the first fabric being able to lengthen along the first general direction during the shaping of the pneumatic tyre.

Document WO2017/103491 presents a pneumatic tyre of similar structure in which the filamentary elements of the first and second structures have been pre-coated with adhesive before being incorporated into the assembly in order to prevent variations in their length during heat treatments which would risk modifying the geometry of the assembly, and therefore its expected operation in the pneumatic tyre.

It can therefore be seen that it is important for the geometry of the assembly to be respected at the end of the various stages of manufacture of a pneumatic tyre, or of a rubber article comprising such an assembly. In particular, the load-bearing filamentary portions of each load-bearing filamentary element must be tensioned uniformly between the first and second structures in order to effectively take up at least part of the load applied to a pneumatic tyre when the latter is fitted to a vehicle. However, small variations in the positioning of the assembly may exist during the manufacture of the rubber article or of the pneumatic tyre, inducing small variations in length from one load-bearing filamentary element to another which could lead to differences in tension between the load-bearing filamentary elements, or even leaving some load-bearing filamentary elements partially tensioned between the two fabrics of the assembly while others are tensioned.

The object of the present invention is to propose an assembly solving these problems, with, in particular, load-bearing filamentary elements whose properties allow them to be tensioned uniformly at the end of the manufacture of a rubber article or a pneumatic tyre incorporating the assembly, thus both allowing simpler manufacture, and making it possible to obtain the expected operation of said article or tyre.

### DETAILED DESCRIPTION OF THE INVENTION

The invention relates to at least one of the following embodiments:
1. Assembly comprising:
   a. a first fabric, having a longitudinal edge extending in a first direction (G1);
   b. a second fabric, comprising a longitudinal edge extending in a second direction (G2), the first direction (G1) and the second direction (G2) being substantially parallel;
   c. a load-bearing structure comprising load-bearing filamentary elements made of heat-shrinkable textile material connecting the first fabric to the second fabric, each load-bearing filamentary element comprising at least one load-bearing filamentary portion extending between the first and the second fabric;
   characterized in that the load-bearing filamentary elements exhibit a thermal contraction CT, measured after 2 min at 185° C., greater than or equal to 5%.
2. Assembly according to the preceding embodiment, wherein each load-bearing filamentary element exhibits a thermal contraction CT, measured after 2 min at 185° C., strictly greater than 5%, preferably greater than or equal to 6%, preferably greater than or equal to 8%.
3. Assembly according to any one of the preceding embodiments, wherein the load-bearing filamentary elements are made of a polyamide material, preferably selected from aliphatic polyamides, preferably from polyamides 4-6, 6, 6-6, 11, 12, and very preferably nylon 6-6.
4. Assembly according to any one of the preceding embodiments wherein the load-bearing filamentary elements comprise at least one multifilament strand comprising several monofilaments.
5. Assembly according to any one of embodiments 1 to 3, wherein the load-bearing filamentary elements consist of a single monofilament.
6. Assembly according to any one of the preceding embodiments, wherein each load-bearing filamentary element has a count in the range from 8 Tex to 210 Tex, preferably from 23 Tex to 140 Tex, and more preferably from 45 Tex to 70 Tex.
7. Assembly according to any one of the preceding embodiments, wherein each load-bearing filamentary element is coated with an adhesive composition.
8. Assembly according to preceding embodiment, wherein the adhesive composition is a
Resorcinol-Formaldehyde-Latex, termed RFL, adhesive, or an adhesive composition based on a phenol-aldehyde resin and on a latex.
9. Assembly according to any one of the embodiments 7 and 8, wherein the adhesive composition is cross-linked.
10. Assembly according to any one of the preceding embodiments, wherein, prior to being incorporated into the assembly, each load-bearing filamentary element of the load-bearing structure is subjected to a bonding treatment comprising at least:
   a. a so-called adhesive-coating step of bringing the load-bearing filamentary element into contact with an adhesive composition, and
   b. a so-called adhesive-drying heat treatment step at a temperature ranging from 100 to 230° C., preferably from 160 to 230° C. for a period ranging from 30 to 300 s,
   the load-bearing filamentary element being maintained under a tension of between 0.2 and 4.0 daN, preferably of between 0.2 and 3 daN, and more preferably of between 0.2 and 1 daN during the bonding treatment.
11. Assembly according to the preceding embodiment, wherein the bonding treatment comprises, prior to the bonding step, a so-called priming step of bringing the load-bearing filamentary element into contact with an adhesion primer composition.
12. Assembly according to the preceding embodiment, wherein the bonding treatment comprises, between the priming step and the bonding step, a so-called primer drying heat treatment step at a temperature ranging from 100 to 230° C., preferably from 160 to 230° C., for a period ranging from 30 to 300 s.
13. Assembly according to any one of the preceding embodiments, wherein the first fabric comprises first filamentary elements, called warp elements, substantially parallel to each other and extending in a first direction (C1) called warp direction, substantially parallel to the first general direction (G1), and wherein, for any elongation of the first fabric in the first general direction (G1) less than or equal to 2×π×H/L, there are first warp filamentary elements that are unbroken, with 0<H≤K×H0, H0 representing in m the mean straight-line distance between an internal face of the first fabric and an internal face of the second fabric when each load-bearing filamentary portion is at rest, L representing the length at rest of the first fabric in the first general direction (G1) and K=1.3.
14. Assembly according to any one of the preceding embodiments, wherein the maximum force developed by the first fabric is greater than or equal to (P0×(L/2π+H)×l)/2, where l is the width of the first fabric measured perpendicular to the first general direction and expressed in m, and P0 is equal to 100000 Pa.
15. Impregnated assembly comprising an assembly according to any one of the preceding embodiments, the first fabric being impregnated at least in part with a composition referred to as the first polymeric composition, and the second fabric being impregnated at least in part with a composition referred to as the second polymeric composition.
16. Rubber article comprising an assembly according to any one of embodiments 1 to 14, or an impregnated assembly according to embodiment 15.
17. Tyre comprising an assembly according to any one of embodiments 1 to 14, or an impregnated assembly according to embodiment 15.
18. Tyre according to the preceding embodiment comprising a crown having two axial ends each extended, radially inwards, by a sidewall then by a bead intended to come into contact with a rim, the assembly consisting of the crown, the two sidewalls and the two beads delimiting a toric interior cavity and at least one bead, the tyre comprising an assembly according to any one of the arrangements of the invention, intended to react at least part of the nominal load Z applied to the tyre mounted on its rim and inflated to its nominal pressure P, the first fabric being fixed to the radially inner part of the crown and the second fabric at least partially delimiting the radially inner part of the toric cavity, the load-bearing structure extending continuously in the toric interior cavity, so that, when the tyre is subjected to a nominal load Z, the load-bearing filamentary elements, connected to a portion of tyre in contact with the ground, are subjected to buckling in compression and at least a part of the load-bearing filamentary elements, connected to the portion of tyre not in contact with the ground, are in tension.
19. Tyre according to the preceding embodiment wherein the toric cavity is completely delimited in its radially inner part by at least one second fabric of an assembly according to any one of embodiments 1 to 14.
20. Tyre according to embodiment 18, wherein the toric cavity is partially delimited in its radially inner part by at least one second fabric of an assembly according to any one of embodiments 1 to 14.
21. Tyre according to the preceding embodiment comprising:
   a. a crown having two axial ends each extended, radially inwards, by a sidewall then by a bead intended to come into contact with a rim, the assembly consisting of the crown, the two sidewalls and the two beads defining a toric interior cavity,
   b. at least one bead being extended axially inwards by a cantilevered flexible base comprising a free end,
   c. the flexible base comprising an anchoring portion for anchoring to the bead and a rigid main-span portion, extending axially inwards from the anchoring portion to the free end,
   the tyre comprising an assembly according to one of embodiments 1 to 14 or an impregnated assembly according to embodiment 15, intended to react at least part of the nominal load Z applied to the tyre mounted on its rim and inflated to its nominal pressure P, the first fabric being fixed to the radially inner part of the crown and the second fabric being fixed to the flexible base, the load-bearing structure extending continuously into the toric interior cavity, such that, when the tyre is subjected to a nominal load Z, the load-bearing filamentary elements, connected to a portion of the tyre in contact with the ground, are subjected to buckling in compression and at least a part of the load-bearing filamentary elements, connected to the portion of the tyre not in contact with the ground, are in tension.

### Definitions

The carbon-comprising compounds mentioned in the description can be of fossil or biobased origin. In the latter case, they may be partially or completely derived from biomass or be obtained from renewable starting materials derived from biomass. Polymers, plasticizers, fillers, and the like, are concerned in particular.

“Substantially parallel” or “extending substantially along”, mean that the angle formed by the two directions in question is less than 10°, preferably less than 5°, preferably less than 2° and very preferably less than or equal to error in angle measurement by a suitable method.

The “general direction” of an object means the general direction along which the object extends along its greatest length. For a fabric, the general direction of the fabric is parallel to the longitudinal edges of the fabric. Thus, for example, a fabric wound on a reel of revolution around an axis has a general direction substantially parallel to the direction of unwinding of the fabric (i.e. the circumferential direction) which is perpendicular to the axial and radial directions of the reel.

Any range of values denoted by the expression “between a and b” represents the range of values extending from more than a to less than b (namely excluding the end-points a and b), whereas any range of values denoted by the expression “from a to b” means the range of values extending from the end-point “a” as far as the end-point “b”, namely including the strict end-points “a” and “b”.

The expression “element based on”, means an element comprising the mixture and/or the product of the in-situ reaction of the various constituents or materials used, some of these constituents or materials being able to react and/or being intended to react with one another, at least partially, during the various phases of manufacture of the element.

Herein, a filamentary element means any longilineal element of great length relative to its cross section, whatever the shape of the latter, for example circular, oblong, rectangular or square, or even flat, it being possible for this filamentary element to be twisted or wavy, for example. When its cross section is circular in shape, the diameter of this section is preferably less than 5 mm, more preferably comprised in a range ranging from 100 μm to 1.2 mm.

### Assembly

The principle of the assembly according to the invention is to have a load-bearing structure comprising load-bearing elements connecting the first fabric and the second fabric, and capable, once the assembly is arranged in the rubber article or the pneumatic tyre, of bearing at least part of the load applied to said article or tyre by tensioning a part of the load-bearing elements positioned outside of the contact patch, the load-bearing elements positioned in the contact patch being subjected to buckling because they are subjected to a compressive force and therefore do not contribute to the bearing of the applied load.

During the steps of crosslinking of the rubber article, and in particular of the pneumatic tyre, into which the assembly according to the invention is integrated, the load-bearing filamentary elements, of which the thermal contraction is greater than 5%, contract so as to absorb any excess length that may originate from the geometric characteristics of the load-bearing filamentary elements or else from offsets in the positioning of the assembly according to the invention during the making of the rubber article or of the pneumatic tyre according to the invention. Thus, at the end of the crosslinking steps, the load-bearing filamentary elements are tensioned in a homogeneous manner, each being able to take part in reacting at least part of the applied load, and making it possible to obtain the expected operation of said article or tyre.

### First Fabric of the Assembly According to the Invention

The first fabric of the assembly according to the invention has a longitudinal edge extending in a first general direction (G1).

In a preferred embodiment, the first fabric is arranged so that, for any non-zero stress, expressed in N, less than or equal to (P0×(L/2π+H)×l)/2 exerted on the first fabric in the first general direction, the first fabric has a non-zero elongation in the first general direction.

In this expression as well as in the rest of the presentation, 1 is the width of the first fabric expressed in metres and P0=100000 Pa, with 0<H≤K×H0, H0 representing in metres the mean straight-line distance between an internal face of the first fabric and an internal face of the second fabric when each load-bearing filamentary portion is at rest, L representing the length at rest of the first fabric in the first general direction (G1) and K=1.2.

In a preferred embodiment, the first fabric is arranged so that, for any elongation of the first fabric in the first general direction less than or equal to (2π×H)/L, the first fabric develops a force, expressed in N, in the first general direction less than or equal to (P0×(L/2π+H)×l)/2. The force developed is measured by applying standard NF EN ISO 13934-1 of July 2013.

Thus, the first fabric can be deformed under a relatively low stress loading making it possible, during the method of manufacturing the tyre, to use a suitable shaping stress loading that carries no risk of damaging the rough form.

In one embodiment, the maximum force of the first fabric in the first general direction is greater than (P0×(L/2π+H)×l)/2. The maximum force is the force needed to obtain the elongation at the maximum force as defined in standard NF EN ISO 13934-1 of July 2013. Thus, with the imposed stress loading, breakage of the first fabric during shaping is avoided.

Advantageously, P0=80000 Pa, preferably P0=60000 Pa, more preferably P0=40000 Pa. The lower P0 is, the more possible it is to use low stress loadings during the method of manufacturing the tyre, and the lower the risk of damaging the rough form during this method.

Preferably, the first fabric comprises first filamentary elements, referred to as warp elements, which are substantially mutually parallel and extend in a first direction (C1), referred to as the warp direction, substantially parallel to the first direction (G1). Preferably, for any elongation of the first fabric in the first general direction (G1) less than or equal to 2×π×H/L, the first filamentary elements are unbroken. Each first filamentary element may, for example, be an extensible filamentary element as described in applications WO2018/130782 and WO2018/130783.

Because the first warp direction is substantially parallel to the first general direction and because the first fabric is sufficiently deformable, the process for manufacturing a pneumatic tyre comprising the assembly according to the invention is greatly facilitated. Specifically, the first fabric can be deformed through the elongation of the first filamentary element without breaking, so that it lengthens enough to follow the shaping imposed upon it during the manufacture of the pneumatic tyre.

Preferably, the first fabric comprises first filamentary elements, referred to as weft elements, which are substantially mutually parallel and intertwine with the first filamentary warp elements. In this preferred embodiment, the first fabric comprises, in a way known to those skilled in the art, a weave characterizing the intertwining of the first filamentary warp and weft elements. According to the embodiments, this weave is of plain, twill or satin type. Preferably, in order to confer good mechanical properties when used in a pneumatic tyre, the weave is of the plain-weave type.

Preferably, the first warp and weft directions make with one another an angle ranging from 70° to 90°, preferably substantially equal to 90°.

The mechanical characteristics of such fabrics, such as their tensile stiffness and their maximum tensile strength, in the direction of the filamentary warp or weft elements, are dependent upon the characteristics of the filamentary elements, such as, in the case of textile filamentary elements, the count, expressed in tex or g/1000 m, the tenacity, expressed in cN/tex, and the standard contraction, expressed in %, these filamentary elements being distributed according to a given density, expressed in number of threads/dm. All these characteristics are dependent on the constituent material of the filamentary elements and on their process of manufacture.

In one embodiment, each filamentary load-bearing element comprises a first filamentary portion for anchoring each filamentary load-bearing element in the first fabric, prolonging the filamentary load-bearing portion in the first fabric.

Preferably, each anchoring first filamentary portion is interlaced with the first fabric. Such an assembly exhibits the advantage of being able to be manufactured in a single stage. However, it is also possible to envisage manufacturing the assembly in two stages, a first stage of manufacture of the first fabric and a second stage of interlacing the filamentary load-bearing element or elements with the first fabric. In both cases, the interlacing of each load-bearing element with the first fabric makes it possible to ensure the mechanical anchoring of each load-bearing element in the first fabric and thus to confer the desired mechanical properties on the load-bearing structure.

In one embodiment, in order to ensure the mechanical anchoring of the filamentary anchoring portion, each first filamentary anchoring portion is wound at least in part around at least one first filamentary element of the first fabric.

Preferably, the first fabric comprises:
first filamentary elements, referred to as warp elements, which are substantially mutually parallel and extend in a first direction, referred to as the warp direction, substantially parallel to the first general direction, and
first filamentary elements, referred to as weft elements, which are substantially mutually parallel and extend in a first direction, referred to as the weft direction, interlacing with the first filamentary warp elements,
   each first filamentary anchoring portion being wound at least in part around at least a first filamentary weft element of the first fabric, preferably around at least two first filamentary weft elements that are adjacent in the first general direction.

In one embodiment, each first filamentary anchoring portion extends in a direction substantially parallel to the first general direction.

Preferably, each first filamentary anchoring portion passes alternately from one face of the first fabric to the other face of the first fabric between two first filamentary weft elements that are adjacent and around which the first filamentary anchoring portion is wound.

Highly preferably, the first filamentary warp elements extend continuously along the entire length of the first fabric.

### Second Fabric of the Assembly

In one embodiment, the second fabric comprises:
second filamentary elements, referred to as warp elements, which are substantially mutually parallel and extend in a second direction (C2), referred to as the warp direction, and
second filamentary elements, referred to as weft elements, which are substantially mutually parallel and extend in a second direction, referred to as the weft direction, intertwining with the second filamentary warp elements.

In this preferred embodiment, the second fabric comprises, in a way known to those skilled in the art, a weave characterizing the intertwining of the second filamentary warp and weft elements. According to the embodiments, this weave is of plain, twill or satin type. Preferably, in order to confer good mechanical properties when used in a pneumatic tyre, the weave is of the plain-weave type.

Advantageously, the second warp and weft directions make with one another an angle ranging from 70° to 90°, preferably substantially equal to 90°.

Preferably, the second fabric extends in a second general direction (G2), the second warp direction (C2) of the second filamentary elements being substantially parallel to the second general direction (G2). Such a second fabric allows for a far easier method of manufacturing the assembly and the pneumatic tyre.

In another embodiment, the second fabric is a knit comprising interwoven loops.

In one embodiment, each load-bearing filamentary element comprises a second filamentary portion for anchoring each load-bearing filamentary element in the second fabric extending the load-bearing filamentary portion in the second fabric.

Preferably, each second filamentary anchoring portion is interlaced with the second fabric. Such an assembly exhibits the advantage of being able to be manufactured in a single stage. However, it is also possible to envisage manufacturing the assembly in two stages, a first stage of manufacture of the second fabric and a second stage of interlacing the filamentary load-bearing element or elements with the second fabric. In both cases, the interlacing of each load-bearing element with the second fabric makes it possible to ensure the mechanical anchoring of each load-bearing element in the second fabric and thus to confer the desired mechanical properties on the load-bearing structure.

In one embodiment, in order to ensure the mechanical anchoring of the filamentary anchoring portion, each second filamentary anchoring portion is wound at least in part around at least one second filamentary element of the second fabric.

Preferably, the second fabric comprises:
second filamentary elements, referred to as warp elements, which are substantially mutually parallel and extend in a second direction, referred to as the warp direction, and
second filamentary elements, referred to as weft elements, which are substantially mutually parallel and extend in a second direction, referred to as the weft direction, intertwining with the second filamentary warp elements,
   each second filamentary anchoring portion being wound at least in part around at least a second filamentary weft element of the second fabric, preferably around at least two second filamentary weft elements that are adjacent in the second general direction.

In one embodiment, each second filamentary anchoring portion extends in a direction substantially parallel to the second general direction.

Preferably, each second filamentary anchoring portion passes alternately from one face of the second fabric to the other face of the second fabric between two second filamentary weft elements that are adjacent and around which the second filamentary anchoring portion is wound.

Highly preferably, the second filamentary warp elements extend continuously along the entire length of the second fabric.

### Load-Bearing Structure

The assembly according to the invention comprises a load-bearing structure comprising load-bearing filamentary elements made of heat-shrinkable textile material connecting the first fabric to the second fabric, each load-bearing filamentary element comprising at least one load-bearing filamentary portion extending between the first and the second fabric. Each load-bearing filamentary element exhibits a thermal contraction CT, measured after 2 min at 185° C., greater than or equal to 5%, preferably strictly greater than 5%, preferably greater than or equal to 6%, preferably greater than or equal to 8%. Each load-bearing filamentary element is preferably coated with an adhesive, preferably crosslinked adhesive, composition.

To measure the thermal contraction of the load-bearing filamentary elements, a 250 mm test specimen is placed under very low tension using a mass of 4.5 g at room temperature (25° C.). Its length L0 is measured before exposure to temperature. The length of the test specimen L1 is measured after exposure to a temperature of 185° C. for 2 min. The thermal contraction CT is calculated using:

CT=(L0−L1)/L0×100.

As a preference, each load-bearing filamentary element is coated with an adhesive composition, preferably with a cross-linked adhesive composition, using a bonding treatment comprising at least:

a. a so-called adhesive-coating step of bringing the load-bearing filamentary element into contact with an adhesive composition, and

b. a so-called adhesive-drying heat treatment step at a temperature ranging from 100 to 230° C., preferably from 160 to 230° C. for a period ranging from 30 to 300 s, the load-bearing filamentary element being maintained under a tension of between 0.2 and 4.0 daN, preferably of between 0.2 and 3 daN, and more preferably of between 0.2 and 1 daN during the bonding treatment.

The conditions of the heat treatment associated with the nature of, and with maintaining the tension in, the load-bearing filamentary element during the bonding treatment make it possible to preserve a high thermal contraction of the coated load-bearing element, which allows a simplified implementation of the assembly according to the invention.

The adhesive composition used may be an “RFL” (resorcinol-formaldehyde-latex) adhesive. These RFL adhesives comprise, in a well-known way, a thermosetting phenolic resin, obtained by the condensation of resorcinol with formaldehyde, and one or more latices of diene rubber in aqueous solution. It should be remembered that a latex is a stable dispersion of microparticles of elastomer(s) in suspension in an aqueous solution.

The diene elastomer of the latex is preferably a diene elastomer selected from the group consisting of polybutadienes, butadiene copolymers, polyisoprenes, isoprene copolymers and mixtures of these elastomers. It is even more preferentially selected from the group consisting of butadiene copolymers, vinylpyridine/styrene/butadiene terpolymers, natural rubber, and mixtures of these elastomers.

The adhesive composition may also be one of the adhesives based on a phenol-aldehyde resin described in applications WO 2013/017421, WO 2013/017422, WO 2013/017423, WO2015007641 and WO2015007642.

Preferably, the bonding treatment comprises, prior to the bonding step, a so-called priming step of bringing the load-bearing filamentary element into contact with an adhesion primer composition. Thus, the load-bearing filamentary element is coated with a layer of an adhesion primer, itself coated with a layer of adhesive composition. One example of an adhesion primer is an epoxy resin and/or an isocyanate compound, possibly blocked. The priming step is preferably followed by a so-called primer-drying heat treatment step at a temperature ranging from 100 to 230° C., preferably from 160 to 230° C., for a period ranging from 30 to 300 s.

Preferably, the load-bearing filamentary elements exhibit, prior to the bonding treatment, a thermal contraction CT, measured after 2 min at 185° C., greater than 5%.

Each load-bearing filamentary element is made of heat-shrinkable textile material. By textile, it is meant that each load-bearing filamentary element is non-metallic, for example made of a material selected from a polyester, a polyamide, a polyketone, a cellulose, a natural fibre or a mixture of these materials.

Mention may be made, among polyesters, for example, of PET (polyethylene terephthalate), PEN (polyethylene naphthalate), PBT (polybutylene terephthalate), PBN (polybutylene naphthalate), PPT (polypropylene terephthalate) or PPN (polypropylene naphthalate). Mention may be made, among polyamides, of aliphatic polyamides such as polyamides 4-6, 6, 6-6 (nylon), 11 or 12.

Preferably, the load-bearing filamentary element is based on a polyamide material, very preferably nylon. Load-bearing filamentary elements made of nylon have a thermal contraction that is particularly suitable for use in the assembly according to the invention. Each load-bearing filamentary element is a textile assembly comprising one or more mono-filament or multi-filament textile fibres, which may or may not be twisted together. Thus, in one embodiment, it will be possible to have an assembly in which the fibres are substantially parallel to one another. In another embodiment, it will be possible to also have an assembly in which the fibres are helically wound. In yet another embodiment, each load-bearing filamentary element consists of a monofilament. Each monofilament or multifilament fibre has a diameter of between 5 and 20 μm, for example 10 μm.

Each load-bearing filamentary element, in particular each load-bearing filamentary portion which connects the internal faces of the first and second fabrics to one another, can be characterized geometrically by its length at rest LP and by its mean section SP, which is the mean of the sections obtained by sectioning the load-bearing filamentary portion on all the surfaces parallel to the first and second fabrics and comprised between the first and second fabrics. In the most frequent case of a constant cross section of the load-bearing filamentary element and of the load-bearing filamentary portion, the mean cross section SP is equal to this constant cross section.

Each load-bearing filamentary element, in particular each load-bearing portion, typically has a smaller characteristic dimension E of its mean section SP, preferably at most equal to 0.02 times the maximum spacing between the two internal faces of the first and second fabrics (which corresponds to the mean radial height H of the inner annular space when the assembly is arranged within a pneumatic tyre in the absence of load applied to the pneumatic tyre and in the absence of pressure in the pneumatic tyre) and an aspect ratio R of its mean section SP preferably at most equal to 3. A smaller characteristic dimension E of the mean section SP of the load-bearing element at most equal to 0.02 times the mean radial height H of the internal annular space rules out any massive load-bearing element having a large volume. In other words, when it is filamentary, each load-bearing element has high slenderness in the radial direction, allowing it to buckle on passing through the contact patch. Outside the contact patch, each filamentary load-bearing element returns to its initial geometry, since its buckling is reversible. Such a filamentary load-bearing element has good resistance to fatigue.

An aspect ratio R of its mean section SP at most equal to 3 means that the largest characteristic dimension V of its mean section SP is at most equal to 3 times the smallest characteristic dimension E of its mean section SP. By way of example, a circular mean section SP, having a diameter equal to d, has an aspect ratio R=1; a rectangular mean section SP, having a length V and a width V′ has an aspect ratio R=V/V′; and an elliptical mean section SP, having a major axis B and a minor axis B′, has an aspect ratio R=B/B′.

A load-bearing filamentary element has mechanical behaviour of the filamentary type, that is to say that it can be subjected only to tensile or compression forces along its mean line.

The load-bearing filamentary elements are arranged so that they lie in mechanically unconnected pairs, in a space delimited by the first and second fabrics. Thus, the load-bearing elements behave independently in mechanical terms. For example, the load-bearing elements are not connected together so as to form a network or a lattice.

In a preferred embodiment, the load-bearing structure comprises a plurality of identical load-bearing filamentary elements, that is to say elements of which the geometrical characteristics and constituent materials are identical.

In one embodiment, each load-bearing filamentary element extends alternately from the first fabric towards the second fabric and from the second fabric towards the first fabric, when progressing along the load-bearing filamentary element.

### Fabric Zones

In a preferred embodiment making it possible to effectively shape the first fabric of the assembly according to the invention, the first fabric comprises:
a first group of zones comprising at least one transverse straight zone (Z1), each transverse straight zone (Z1) of the first group of zones being arranged so as to allow elongation of at least one transverse straight zone (Z1) of the first group of zones in the first general direction (G1), preferably a lengthening of each transverse straight zone (Z1) of the first group of zones in the first general direction (G1),
a second group of zones comprising at least one transverse straight zone (Z2), each transverse straight zone (Z2) of the second group of zones being arranged in such a way as to prevent breakage in said transverse straight zone (Z2).

By definition, a transverse straight zone of the fabric is longitudinally delimited by two imaginary straight lines substantially perpendicular to the first general direction of the fabric. A transverse straight zone extends across the entire width of the fabric, which means to say that the transverse straight zone is transversely delimited by the longitudinal edges of the fabric.

Preferably, each transverse straight zone of the first group of zones is arranged so as to allow an elongation of each transverse straight zone of the first group of zones in the first general direction for any non-zero stress less than or equal to (P0×(L/2π+H)×l)/2 exerted on the first fabric in the first general direction, and for any elongation of the first fabric in the first general direction less than or equal to 2×π×H/L.

Preferably, each transverse straight zone of the second group of zones is arranged so as to prevent breakage of each transverse straight zone of the second group of zones for any non-zero stress less than or equal to (P0×(L/2π+H)×l)/2 exerted on the first fabric in the first general direction, and for any elongation of the first fabric in the first general direction less than or equal to 2×π×H/L.

In one embodiment making it possible to obtain transverse straight zones of the second group of zones that are non-deformable, each transverse straight zone of the second group of zones is arranged so as to prevent elongation of each transverse straight zone of the second group of zones in the first general direction, in particular and preferably for any non-zero stress less than or equal to (P0×(L/2π+H)×l)/2 exerted on the first fabric in the first general direction, and for any elongation of the first fabric in the first general direction less than or equal to 2×π×H/L.

In another embodiment making it possible to obtain transverse straight zones of the second group of zones that are deformable, each transverse straight zone of the second group of zones is arranged so as to allow elongation of each transverse straight zone of the second group of zones in the first general direction, this elongation preferably being at most equal to 20%, preferably 15%, and more preferably 10%, of the elongation of each transverse straight zone of the first group of zones in the first general direction, in particular and preferably for any non-zero stress less than or equal to (P0×(L/2π+H)×l)/2 exerted on the first fabric in the first general direction, and for any elongation of the first fabric in the first general direction less than or equal to (2π×H)/L.

Preferably, each transverse straight zone of the first group of zones is arranged so as to allow elongation of each first filamentary warp element in the first general direction in each transverse straight zone of the first group of zones, in particular and preferably for any non-zero stress less than or equal to (P0×(L/2π+H)×l/2 exerted on the first fabric in the first general direction, and for any elongation of the first fabric in the first general direction less than or equal to (2π×H)/L.

The elongation of each first filamentary warp element can be obtained by any means, for example by first filamentary elements as described in applications WO2018/130782 and WO2018/130783.

Preferably, each transverse straight zone (Z1) of the first group of zones is arranged in such a way as to allow separation of the filamentary weft elements relative to each other in the first general direction in each transverse straight zone of the first group of zones, in particular and preferably for any non-zero stress less than or equal to (P0×(L/2π+H)×l)/2 exerted on the first fabric in the first general direction, and for any elongation of the first fabric in the first general direction less than or equal to (2π×H)/L.

In a preferred embodiment, each transverse straight zone (Z2) of the second group of straight zones is arranged in such a way as to prevent breakage of each first filamentary warp element in each transverse straight zone (Z2) of the second group of zones, in particular and preferably for any non-zero stress less than or equal to (P0×(L/2π+H)×l)/2 exerted on the first fabric in the first general direction, and for any elongation of the first fabric in the first general direction less than or equal to (2π×H)/L.

In one embodiment making it possible to obtain transverse straight zones (Z2) of the second group of zones that are non-deformable, each transverse straight zone (Z2) of the second group of zones is arranged so as to prevent elongation of each first filamentary warp element in the first general direction in each transverse straight zone (Z2) of the second group of zones, in particular and preferably for any non-zero stress less than or equal to (P0×(L/2π+H)×l)/2 exerted on the first fabric in the first general direction, and for any elongation of the first fabric in the first general direction less than or equal to (2π×H)/L.

In another embodiment making it possible to obtain transverse straight zones (Z2) of the second group of zones that are deformable, each transverse straight zone (Z2) of the second group of zones is arranged so as to allow elongation of each first filamentary warp element in the first general direction in each transverse straight zone (Z2) of the second group of zones, this elongation preferably being at most equal to 20%, preferably 15%, and more preferably 10% of the elongation of each first filamentary warp element in the first general direction in each transverse straight zone (Z2) of the first group of zones, in particular and preferably for any non-zero stress less than or equal to (P0×(L/2π+H)×l)/2 exerted on the first fabric in the first general direction, and for any elongation of the first fabric in the first general direction less than or equal to (2π×H)/L.

Optionally, in the embodiment using transverse straight zones (Z2) of the second group of zones that are non-deformable, each transverse straight zone (Z2) of the second group of zones is arranged so as to prevent the first filamentary weft elements from separating from each other in the first general direction in each transverse straight zone (Z2) of the second group of zones, in particular and preferably for any non-zero stress less than or equal to (P0×(L/2π+H)×l)/2 exerted on the first fabric in the first general direction, and for any elongation of the first fabric in the first general direction less than or equal to (2π×H)/L.

Optionally, in the embodiment using transverse straight zones (Z2) of the second group of zones that are deformable, each transverse straight zone (Z2) of the second group of zones is arranged in such a way as to allow the first filamentary weft elements to separate from each other in the first general direction in each transverse straight zone (Z2) of the second group of zones, in particular and preferably for any non-zero stress less than or equal to (P0×(L/2π+H)×l)/2 exerted on the first fabric in the first general direction, and for any elongation of the first fabric in the first general direction less than or equal to (2π×H)/L.

In the preferred embodiments described above, each transverse straight zone (Z1) of the first group of zones is a so-called deformable zone. Such zones are deformable under the shaping conditions and contribute to the ability of the first fabric to be shaped. Each transverse straight zone (Z2) of the second group of zones is a so-called non-breakable zone. Optionally, in one embodiment, each transverse straight zone (Z2) of the second group of zones is non-deformable. In another embodiment, each transverse straight zone (Z2) of the second group of zones is deformable but to a much lesser extent than each transverse straight zone (Z1) of the first group of zones. Such zones are unbreakable under the shaping conditions and do not contribute, or contribute very little, to the ability of the first fabric to be shaped. Thus, each so-called deformable transverse straight zone (Z1) of the first group of zones deforms sufficiently to allow the assembly to be shaped and compensates for the non-elongation or the slight elongation of the non-breakable transverse straight zones (Z2) of the second group of zones. The elongation at maximum force of all of the transverse straight zones of the first group of zones will be greater, the shorter and fewer in number are the so-called deformable transverse straight zones of the first group of zones in comparison with the unbreakable transverse straight zones of the second group of zones. At the scale of the filamentary warp elements, those portions of each first filamentary warp element that are situated in each so-called deformable transverse straight zone (Z1) of the first group of zones deform enough to allow the assembly to be shaped and compensate for the non-extension or low extension of those portions of each first filamentary warp element that are situated in the so-called unbreakable transverse straight zones (Z2) of the second group of zones.

Also, each so-called deformable zone of the first group of zones is deformable under a relatively low stress which makes it possible, during the tyre manufacturing process, to use a suitable shaping stress that does not risk damaging the rough form.

In a preferred embodiment, all the transverse straight zones (Z1) of the first group of zones are identical and the elongation at maximum force Art1 of each transverse straight zone (Z1) of the first group of zones in the first general direction satisfies Art1>(2π×H)/SLd1 with SLd1 being the sum of the lengths at rest Ld1 of all the transverse straight zones (Z1) of the first group of zones. The elongation at maximum force is measured in accordance with standard NF EN ISO 13934-1 of July 2013 on samples of transverse straight zones (Z1) of the first group of zones.

Advantageously, in the preceding embodiment, the elongation at break Arc of each first filamentary warp element satisfies Arc>(2π×H)/SLd1. The elongation at break Arc is measured in accordance with standard ASTM D885/D885 MA of January 2010. The elongation at break Arc of each filamentary element is the elongation necessary to obtain the breaking of the first and second filamentary members.

Preferably, for any elongation of each transverse straight zone (Z1) of the first group of zones in the first general direction that is less than or equal to (2π×H)/SLd1, the first fabric develops a force, expressed in N, in the first general direction that is less than or equal to (P0×(L/2π+H)×l)/2, SLd1 being the sum of the lengths at rest of all the transverse straight zones (Z1) of the first group of zones expressed in m. The elongation, the stress exerted and the force developed are determined in accordance with standard NF EN ISO 13934-1 of July 2013.

In one preferred embodiment, each load-bearing filamentary element comprises a first filamentary portion for anchoring each load-bearing filamentary element in the first fabric, prolonging the load-bearing filamentary portion in the first fabric:
each transverse straight zone (Z1) of the first group of zones being devoid of any first filamentary anchoring portion,
each transverse straight zone (Z2) of the second group of zones comprising at least one first filamentary anchoring portion.

Preferably, each transverse straight zone (Z2) of the second group of zones is arranged in such a way as to prevent breakage of each first filamentary anchoring portion, in particular and preferably for any non-zero stress less than or equal to (P0×(L/2π+H)×l)/2 exerted on the first fabric in the first general direction, and for any elongation of the first fabric in the first general direction less than or equal to (2π×H)/L.

Thus, each transverse straight zone (Z2) comprising at least a first filamentary anchoring portion is non-breakable, even under relatively high stress, which makes it possible, during the tyre manufacturing process, to use a suitable shaping stress that does not risk damaging the rough form.

In one embodiment, each transverse straight zone (Z2) of the second group of zones is arranged so as to prevent elongation of each first filamentary anchoring portion in the first general direction, in particular and preferably for any non-zero stress less than or equal to (P0×(L/2π+H)×l)/2 exerted on the first fabric in the first general direction, and for any elongation of the first fabric in the first general direction less than or equal to (2π×H)/L.

In another embodiment, each transverse straight zone (Z2) of the second group of zones is arranged so as to allow elongation of each first filamentary anchoring portion in the first general direction, in particular and preferably for any non-zero stress less than or equal to (P0×(L/2π+H)×l)/2 exerted on the first fabric in the first general direction, and for any elongation of the first fabric in the first general direction less than or equal to (2π×H)/L.

Advantageously, P0=80000 Pa, preferably P0=60000 Pa, more preferably P0=40000 Pa. The lower P0 is, the more possible it is to use low stress loadings during the method of manufacturing the tyre, and the lower the risk of damaging the rough form during this method.

Preferably, each transverse straight zone (Z1) of the first group of zones alternates, in the first general direction, with a transverse straight zone (Z2) of the second group of zones.

Thus, on the scale of the first fabric, uniform deformation of the whole of the first fabric is obtained, this deformation being all the more even the shorter the length at rest of each transverse straight zone in the first general direction. What is meant by the length at rest of a transverse straight zone in the first general direction is the length of the zone in the longitudinal direction in the absence of any external stress loading applied to the zone (other than atmospheric pressure). A transverse straight zone at rest in the first general direction is neither under tension nor in compression in this direction and therefore exhibits zero elongation in this direction.

The assembly according to the invention may be bonded, that is to say coated at least in part with at least one aqueous adhesive composition promoting adhesion between the first filamentary elements of the first fabric and/or the second filamentary elements of the second fabric with an elastomer composition. In a two-layer embodiment, each first and second filamentary element to be coated with adhesive is coated with a layer of an adhesion primer, itself coated with a layer of adhesive composition. In a single-layer embodiment, each first and second filamentary element to be coated with adhesive is coated directly with a layer of adhesive composition. One example of an adhesion primer is an epoxy resin and/or an isocyanate compound, possibly blocked. The adhesive composition used may be a conventional RFL (Resorcinol-formaldehyde-latex) adhesive, or else may be the adhesives described in applications WO 2013/017421, WO 2013/017422, WO 2013/017423, WO2015007641 and WO2015007642. At the end of the bonding of the assembly according to the invention, the load-bearing structure has a sufficient thermal contraction measured at 185° C. after 2 min, greater than or equal to 5%, which makes it easy to implement the assembly according to the invention in a rubber article, in particular a pneumatic tyre, and to obtain the expected operation thereof.

### Manufacture of the Assembly

In a step of forming the assembly according to the invention, the first filamentary elements 64, 66 are assembled so as to form the first fabric 26 and the second filamentary elements 68, 70 are assembled so as to form the second fabric 28. The load-bearing elements 32, which are preferably coated with an adhesive, preferably with a crosslinked adhesive, composition, are also assembled with the first and second fabrics 26, 28. In the embodiment described as an example, the first and second filamentary elements 64, 66, 68, 70 are assembled in a single step, and therefore simultaneously, with the load-bearing elements 32 so as to form the assembly 24. In another embodiment, each first and second fabric 26, 28 is first formed separately, then the first and second fabrics 26, 28 are joined together with the load-bearing elements 32, which are preferably coated with an adhesive, preferably with a crosslinked adhesive, composition. The step of forming the assembly 24 according to the invention is implemented in a manner known to those skilled in the art of weft fabrics.

### Impregnated Assembly

Another subject of the invention is an impregnated assembly, preferably for a pneumatic tyre, the first fabric being impregnated at least in part with a composition referred to as first polymer composition, and the second fabric being impregnated at least in part with a composition referred to as second polymer composition.

“Impregnated”, means that each polymer composition penetrates the fabric at least at the surface. It is therefore possible to have unifacial impregnation with coverage of one side of the fabric by the polymeric composition or bifacial impregnation with coverage of both sides of the fabric by the polymer composition. In both cases, the impregnation makes it possible to create a mechanical anchorage by virtue of the penetration of the polymer composition into the interstices present in the fabrics.

In one embodiment, each polymer composition comprises at least one elastomer, preferably a diene elastomer. Elastomer or rubber (the two terms being synonyms) of the diene type is understood to mean, generally, an elastomer resulting, at least in part (i.e., a homopolymer or a copolymer), from diene monomers (monomers bearing two conjugated or unconjugated carbon-carbon double bonds). This composition can then be in the raw state or in the cured state.

Particularly preferably, the diene elastomer of the rubber composition is selected from the group consisting of polybutadienes (BRs), synthetic polyisoprenes (IRs), natural rubber (NR), butadiene copolymers, isoprene copolymers and the mixtures of these elastomers. Such copolymers are more preferentially selected from the group consisting of butadiene/styrene copolymers (SBRs), isoprene/butadiene copolymers (BIRO, isoprene/styrene copolymers (SIRs), isoprene/butadiene/styrene copolymers (SBIRs) and mixtures of such copolymers.

Each polymer composition can comprise just one diene elastomer or a mixture of several diene elastomers, it being possible for the diene elastomer or elastomers to be used in combination with any type of synthetic elastomer other than a diene elastomer, indeed even with polymers other than elastomers, for example thermoplastic polymers.

Furthermore, in this embodiment, each polymer composition comprises, in addition to the elastomer, preferably the diene elastomer, a reinforcing filler, for example carbon black, a crosslinking system, for example a vulcanization system, and various additives.

In another embodiment, each polymer composition comprises at least one thermoplastic polymer. A thermoplastic polymer is, by definition, hot-meltable. Examples of such thermoplastic polymers are aliphatic polyamides, for example nylon, polyesters, for example PET or PEN, and thermoplastic elastomers.

Thermoplastic elastomers (abbreviated to “TPEs”) are elastomers provided in the form of block copolymers based on thermoplastic blocks. With a structure intermediate between thermoplastic polymers and elastomers, they are formed, in a known way, of rigid thermoplastic, in particular polystyrene, sequences connected by flexible elastomer sequences, for example polybutadiene or polyisoprene sequences for unsaturated TPEs or poly(ethylene/butylene) sequences for saturated TPEs. This is the reason why, in a known way, the above TPE block copolymers are generally characterized by the presence of two glass transition peaks, the first peak (the lower, generally negative, temperature) relating to the elastomer sequence of the TPE copolymer and the second peak (the higher, positive, temperature, typically greater than 80° C. for preferred elastomers of the TPS type) relating to the thermoplastic (for example styrene blocks) part of the TPE copolymer. These TPE elastomers are often triblock elastomers with two rigid segments connected by a flexible segment. The rigid and flexible segments can be positioned linearly, or in a star-branched or branched configuration. These TPE elastomers can also be diblock elastomers with a single rigid segment connected to a flexible segment. Typically, each of these segments or blocks contains at least more than 5, generally more than 10, base units (for example, styrene units and isoprene units for a styrene/isoprene/styrene block copolymer).

Preferably, the thermoplastic elastomer is unsaturated. An unsaturated TPE elastomer is understood to mean, by definition and in a well-known way, a TPE elastomer which is provided with ethylenic unsaturations, that is to say which comprises (conjugated or unconjugated) carbon-carbon double bonds; conversely, a “saturated” TPE elastomer is, of course, a TPE elastomer which is devoid of such double bonds.

The first and second polymeric compositions can be different or identical. For example, said first polymeric composition may comprise a diene elastomer and said second polymeric composition may comprise a thermoplastic elastomer or vice versa.

### Rubber Item

The invention also relates to a rubber item comprising an assembly according to the invention, or an impregnated assembly according to the invention. A rubber article means any type of rubber article such as a ball, a non-pneumatic object such as a non-pneumatic tyre, a conveyor belt.

### Tyre

The invention also relates to a tyre comprising an assembly according to the invention, or an impregnated assembly according to the invention.

The assembly according to the invention, impregnated or not, is particularly suitable for incorporation into a tyre as described, for example, in document WO 2018/130782 or even and preferably as described in document WO 2019/092343.

The invention relates in particular to a tyre comprising a crown having two axial ends each extended, radially inwards, by a sidewall then by a bead intended to come into contact with a rim, the assembly consisting of the crown, the two sidewalls and the two beads delimiting a toric interior cavity and at least one bead, the tyre comprising an assembly according to any one of the arrangements of the invention, intended to react at least part of the nominal load Z applied to the tyre mounted on its rim and inflated to its nominal pressure P, the first fabric being fixed to the radially inner part of the crown and the second fabric at least partially delimiting the radially inner part of the toric cavity, the load-bearing structure extending continuously in the toric interior cavity, so that, when the tyre is subjected to a nominal load Z, the load-bearing filamentary elements, connected to a portion of tyre in contact with the ground, are subjected to buckling in compression and at least a part of the load-bearing filamentary elements, connected to the portion of tyre not in contact with the ground, are in tension.

In a particular arrangement, the toric cavity is completely delimited in its radially inner part by at least one second fabric of any arrangement of the assembly according to the invention.

In another particular arrangement, the toric cavity is partially delimited in its radially inner part by at least one second fabric of any arrangement of the assembly according to the invention.

Thus, in a preferred embodiment of this particular arrangement, a tyre according to the invention will be a tyre, in particular for a passenger vehicle, having an axial width S, intended to be inflated to a nominal pressure P and to be subjected to a nominal load Z, including:
a crown having two axial ends each extended, radially inwards, by a sidewall then by a bead intended to come into contact with a rim, the assembly consisting of the crown, the two sidewalls and the two beads defining a toric interior cavity,
possibly a carcass reinforcement, connecting the two sidewalls together by extending in a radially inner portion of the crown and being anchored, in each bead, to a circumferential reinforcing element,
at least one bead being extended axially inwards by a cantilevered flexible base comprising a free end,
the flexible base comprising an anchoring portion for anchoring to the bead and a rigid main-span portion, extending axially inwards from the anchoring portion to the free end,
the tyre comprising an assembly according to the invention, intended to react at least part of the nominal load Z applied to the tyre mounted on its rim and inflated to its nominal pressure P,
the first fabric being fixed to the radially inner part of the crown and the second fabric being fixed to the flexible base, the load-bearing structure extending continuously into the toric interior cavity, such that, when the tyre is subjected to a nominal load Z, the load-bearing filamentary elements, connected to a portion of the tyre in contact with the ground, are subjected to buckling in compression and at least a part of the load-bearing filamentary elements, connected to the portion of the tyre not in contact with the ground, are in tension.

### Measurement Methods

The elongation at maximum force is measured in accordance with standard NF EN ISO 13934-1 of July 2013. Because this elongation at the maximum force is measured in the first general direction, it corresponds to the elongation of the first fabric beyond which at least one first filamentary element breaks. Other filamentary elements break in the portion of the elongation comprised between the elongation at maximum force and the elongation at break as defined in standard NF EN ISO 13934-1 of July 2013. This measurement can be carried out on an assembly in the natural state, a bonded assembly or else an assembly extracted from a tyre. Preferably, the measurement will be carried out on an assembly in the natural or bonded state.

In the present application, the properties of the first fabric are determined by subjecting the first fabric to a tensile test in accordance with standard NF EN ISO 13934-1 of July 2013. The intrinsic properties of the filamentary elements are determined by subjecting the filamentary elements to a tensile test in accordance with standard ASTM D885/D885 MA of January 2010.

### DESCRIPTION OF THE FIGURES

The invention is illustrated in FIGS. 1 to 4, which are not drawn to scale and are described below:

FIG. 1 Meridian section of a tyre according to the invention, with two symmetrical flexible bases each comprising a flexible anchoring portion.

FIG. 2 Circumferential section of a tyre according to the invention, in the compressed state.

FIG. 3 Top view of the assembly according to the invention before its assembly in the tyre.

FIG. 4 View in cross section of the assembly according to the invention on the plane of section P-P′ shown in FIG. 3, illustrating the load-bearing filamentary elements in a folded state.

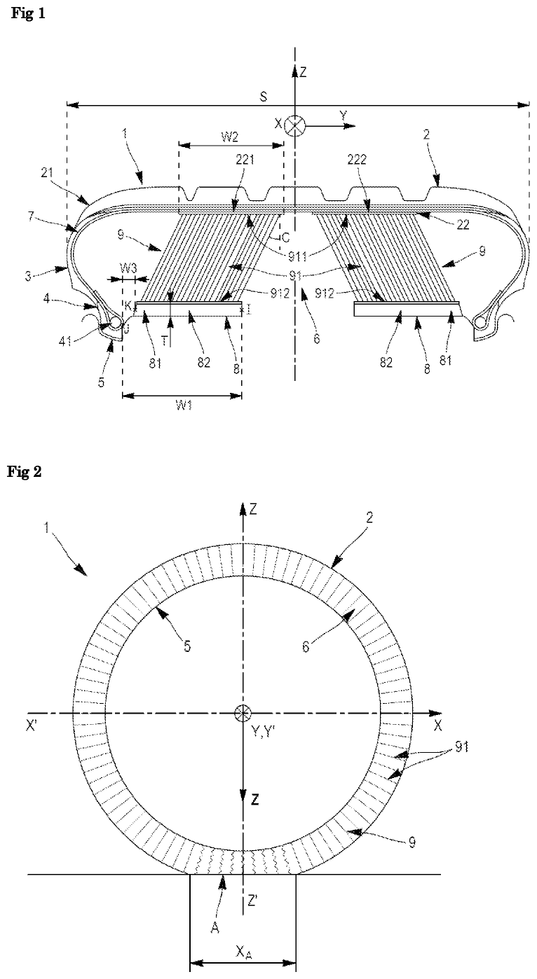

FIG. 1 depicts the meridian section of a tyre 1 according to the invention, with two symmetrical flexible bases 8 each comprising a flexible anchoring portion 81. The tyre 1 comprises a crown 2 having two axial ends 21 each extended, radially inwards, by a sidewall 3 then by a bead 4 intended to come into contact with a rim 5, the assembly defining a toric internal cavity 6. It further comprises a carcass reinforcement 7, connecting the two sidewalls 3 together by extending in a radially inner portion of the crown 2 and anchored, in each bead 4, to a circumferential reinforcing element 41. Each bead 4 is extended axially inwards by a cantilevered flexible base 8 comprising a free end I. The flexible bases 8 extending each bead 4 are symmetrical with respect to an equatorial plane XZ equidistant from the axial ends 21 of the crown 2, and structurally identical. Each flexible base 8 comprises an anchoring portion 81 for anchoring to the bead, and a rigid main-span portion 82, extending axially inwards from the anchoring portion 81 to the free end I. In the case depicted, the anchoring portion 81, consisting of an extension of the carcass reinforcement 7, has a stiffness K2 less than the stiffness K1 of the rigid main-span portion 82. The anchoring portion 81 of the flexible base 8 has an axial width W3, measured between the axially outermost point J of the flexible base 8 in contact with the bead 4, and the axially exterior end K of the main-span portion 82 of the flexible base 8. Each flexible base 8 has an axial width W1, measured between the axially outermost point J of the flexible base 8 in contact with the bead 4, and the axially inner free end I of the flexible base 8. The main-span portion 82 of the flexible base 8 has a mean radial thickness T. The tyre 1 further comprises a load-bearing structure 9, intended to react at least part of the nominal load Z applied to the tyre mounted on its rim 5 and inflated to its nominal pressure P, comprising load-bearing filamentary elements of which the pairwise-independent load-bearing filamentary portions 91 extend continuously in the toric inner cavity 6 between a first fabric 221, of radial width W2, secured to a radially inner interface 22 of the crown and a second fabric 912 connected to the flexible base 8, such that, when the tyre is subjected to a nominal radial load Z, the load-bearing filamentary portions 91, connected to a portion of the tyre in contact with the ground, are subjected to buckling in compression and at least part of the load-bearing filamentary portions 91, connected to the tyre portion not in contact with the ground, are in tension. The identical load-bearing filamentary portions 91 form, with a radial direction ZZ′, an angle C at most equal to 50°.

FIG. 2 shows a circumferential section of a tyre 1 according to the invention, mounted on a rim 5, in its inflated and flattened state, that is to say subjected to a nominal pressure P and a nominal radial load Z. The load-bearing structure 9 comprising load-bearing elements of which the pairwise-independent load-bearing filamentary portions 91 extend continuously in the toric inner cavity 6 between a first fabric secured to a radially inner interface (not depicted) of the crown 2 as far as a second fabric secured to the radially exterior interface of the flexible base (not depicted). The tyre 1, subjected to a nominal radial load Z, is in contact with flat ground by way of a contact patch A, having a circumferential length XA. The load-bearing filamentary portions 91, connected to a tyre portion in contact with the ground, are subjected to buckling in compression and at least part of the load-bearing filamentary portions 91, connected to the tyre portion not in contact with the ground, are in tension.

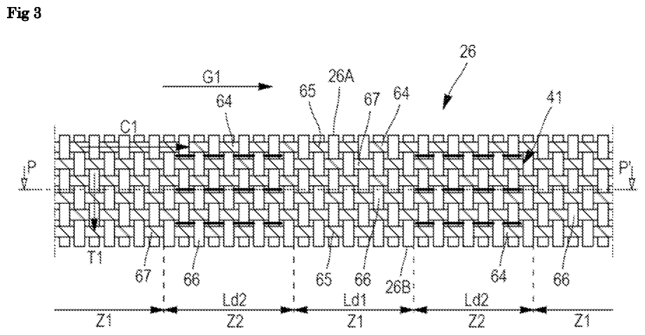

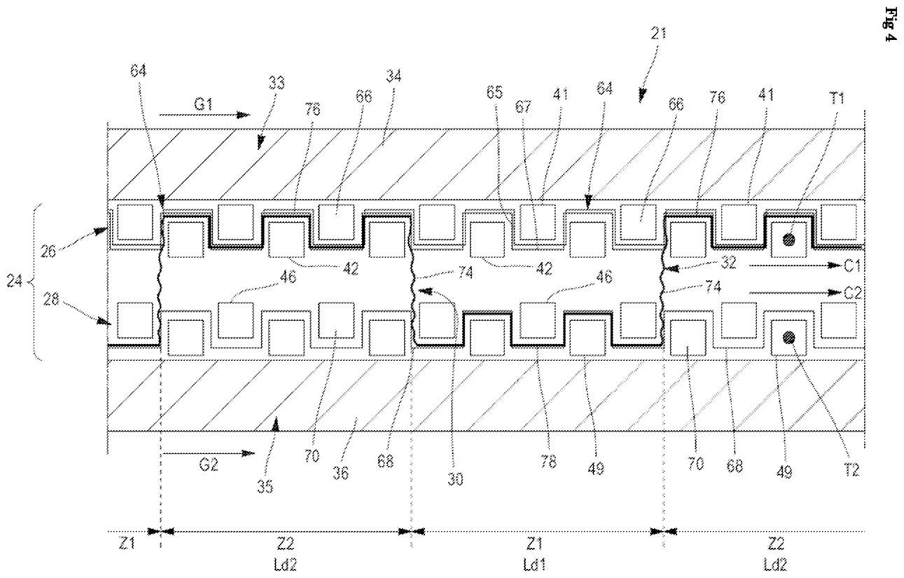

FIGS. 3 and 4 respectively depict a top view of an arrangement of an assembly 24 according to the invention and a section through an arrangement of the assembly on a plane P-P′ as depicted in FIG. 3.

The first fabric 26 comprises two longitudinal edges 26A and 26B. The first fabric 26 extends in a first general direction G1 substantially parallel to each longitudinal edge 26A, 26B. The first fabric 26 comprises first filamentary elements 64, referred to as first filamentary warp elements, and first filamentary elements 66 referred to as first filamentary weft elements. The first filamentary warp elements 64 of the first fabric 26 are substantially mutually parallel and extend in a first direction, referred to as the warp direction C1, substantially parallel to the first general direction G1. The first filamentary weft elements 66 of the first fabric 26 are substantially mutually parallel and extend in a first direction, referred to as the weft direction T1, interlacing with the first filamentary warp elements 64. The first filamentary warp elements 64 extend continuously along the entire length of the first fabric 26.

In a similar way to the first fabric 26, the second fabric 28 comprises two longitudinal edges 28A and 28B. The second fabric 28 extends in a second general direction G2 substantially parallel to each longitudinal edge 28A, 28B. In this instance, the second general direction G2 is substantially parallel to the first general direction G1. The second fabric 28 comprises second filamentary elements 68, referred to as second filamentary warp elements, and second filamentary elements 70 referred to as second filamentary weft elements. The second filamentary warp elements 68 of the second fabric 28 are substantially mutually parallel and extend in a second direction, referred to as the warp direction C2, substantially parallel to the second general direction G2. The second filamentary weft elements 70 of the second fabric 28 are substantially mutually parallel and extend in a second direction, referred to as the weft direction T2, interlacing with the second filamentary warp elements 68. The second filamentary warp elements 68 extend continuously along the entire length of the first fabric 28.

Within each first and second fabric 26, 28, the warp and weft directions form, with one another, an angle ranging from 70° to 90°. In this instance, the angle is substantially equal to 90°.

Within the tyre 1, each first and second warp direction forms an angle less than or equal to 10° with the circumferential direction XX′ of the tyre 1. In the first embodiment, each first and second warp direction forms a substantially zero angle with the circumferential direction XX′ of the tyre 1.

Each filamentary element 64, 66, 68, 70 is a textile filamentary element.

The filamentary elements 64 are all substantially identical. Each first filamentary warp element 64 comprises first and second filamentary members 65, 67. The second filamentary member 67 is substantially rectilinear and the first filamentary member 65 is wound substantially in a helix around the second filamentary member 67 forming loops in a substantially periodic manner (these are not shown). Here, the first filamentary member 65 is a multifilamentary strand made of PET having a count equal to 110 tex and the second filamentary member 67 is an assembly of two multifilamentary strands of 11.5 tex each.

The filamentary elements 66, 68, 70 are all substantially identical, in this instance made of polyethylene terephthalate (PET). In this particular instance, each filamentary element 66, 68, 70 is a spun filamentary element exhibiting a linear density equal to 170 tex and a tenacity equal to 66 cN/tex.

The assembly 24 comprises a load-bearing structure 30 comprising load-bearing filamentary elements 32. Each load-bearing filamentary element 32 extends alternately from the first fabric 26 towards the second fabric 28 and from the second fabric 28 towards the first fabric 26 on moving along the load-bearing filamentary element 32. Each load-bearing filamentary element 32 is a textile load-bearing filamentary element, here made of nylon 6-6 and preferably coated with a crosslinked RFL adhesive.

Each load-bearing filamentary element 32 comprises a load-bearing filamentary portion 74 extending between the first and second fabrics 26, 28, in particular between the internal faces 42 and 46. Each load-bearing filamentary element 32 comprises first and second filamentary anchoring portions 76, 78 for anchoring the load-bearing filamentary element 32 respectively in the first fabric 26 and the second fabric 28. Each first and second filamentary anchoring portion 76, 78 prolongs the load-bearing portion 74 respectively into each first fabric 26 and second fabric 28. Each first and second filamentary anchoring portion 76, 78 is interlaced respectively with each first fabric 26 and second fabric 28. Each first and second filamentary anchoring portion 76, 78 is wound at least in part around respectively at least one first filamentary element 64, 66 of the first fabric 26 and at least one second filamentary element 68, 70 of the second fabric 28. In this way, each filamentary anchoring portion 76, 78 joins two load-bearing filamentary portions 74 together and each load-bearing filamentary portion 74 joins two filamentary anchoring portions 76, 78 together.

In this instance, each first filamentary anchoring portion 76 is wound at least in part around at least a first filamentary weft element 66 of the first fabric 26 and, in this instance, preferably around at least two first filamentary weft elements 66 that are adjacent in the first general direction G1. Similarly, each second filamentary anchoring portion 78 is wound at least in part around at least a second filamentary weft element 68 of the second fabric 28, preferably around at least two second filamentary weft elements 66 that are adjacent in the second general direction G2.

Each first and second filamentary anchoring portion 76, 78 extends in a direction substantially parallel respectively to the first and second general directions G1, G2.

Each first filamentary anchoring portion 76 passes alternately from the face 41 to the face 42 between two first filamentary weft elements 66 that are adjacent and around which the first filamentary anchoring portion 76 is wound. Analogously, each second filamentary anchoring portion 78 passes alternately from the face 46 to the face 49 between two second filamentary weft elements 68 that are adjacent and around which the second filamentary anchoring portion 78 is wound.

The first fabric 26 comprises transverse straight zones Z1 of a first group of zones, each transverse straight zone Z1 having a length at rest Ld1 in the first general direction G1 and extending over the entire width of the first fabric 26. This length Ld1 is the same for all the transverse straight zones Z1 and here equal to 7.9 mm. All the transverse straight zones Z1 of the first group of transverse straight zones are identical.

The first fabric 26 also comprises transverse straight zones Z2 of a second group of zones, each transverse straight zone Z2 having a length at rest Ld2 in the first general direction G1 and extending over the entire width of the first fabric 26. This length Ld2 is the same for all the transverse straight zones Z2 and is here equal to 5.8 mm. All the transverse straight zones Z2 of the second group of transverse straight zones are identical.

Each transverse straight zone Z1 of the first group of zones alternates, in the first general direction or in the circumferential direction XX′, with a transverse straight zone Z2 of the second group of zones.

When the first fabric is at rest as is depicted in FIG. 4, the sum of the lengths at rest Ld1 and Ld2 of all the transverse straight zones in the first general direction G1 is substantially equal to L. In this instance, for a length L of the assembly 24 and therefore a length L of the first fabric L=1692 mm having a width 1=220 mm, the sum SLd1 of the lengths at rest Ld1 of the transverse straight zones Z1 is equal to 975 mm, and the sum of the lengths at rest Ld2 of the transverse straight zones Z2 is equal to 717 mm. The first fabric thus comprises 123 whole transverse straight zones Z1 and Z2, and one incomplete transverse straight zone Z2.

In the particular arrangement shown in FIG. 4, corresponding to a particular arrangement of an impregnated assembly 21 according to the invention, the first fabric 26 is impregnated at least in part with a first layer 33 of a first polymer composition 34. The second fabric 28 is impregnated at least in part with a second layer 35 of a second polymer composition 36.

### EXAMPLES

The thermal contractions of the load-bearing structures of different assemblies whose structure is similar to that presented in FIG. 4 are compared.

A first assembly corresponds to the assembly described in document WO 2018/130783.

The first assembly in accordance with the teaching of document WO 2018/130783 comprises a first fabric comprising first filamentary warp elements each comprising a first filamentary member consisting of a multifilament strand made of PET and having a count equal to 110 tex and a second filamentary member consisting of an assembly of two multifilament strands of 11.5 tex each, made of rayon. The first filamentary member is helically wound around the second filamentary member, forming a wrap around the second filamentary member. Each first filamentary member is therefore, according to the terminology of those skilled in the art, a wrapped thread. The first fabric also comprises first filamentary weft elements consisting of a multifilament strand made of PET having a count equal to 170 tex. This assembly also comprises a second fabric comprising second filamentary warp elements and second filamentary weft elements, each of these elements consisting of a multifilament strand made of PET having a count equal to 170 tex, as well as a load-bearing structure consisting of filamentary elements made of PET with a count of 55 tex.

A second assembly in accordance with the invention comprises a first fabric comprising first filamentary warp elements each comprising a first filamentary member consisting of a multifilament strand made of PET having a count equal to 110 tex and second filamentary member consisting of an assembly of two multifilament strands of 11.5 tex each, made of rayon. The first filamentary member is helically wound around the second filamentary member, forming a wrap around the second filamentary member. Each first filamentary member is therefore, according to the terminology of those skilled in the art, a wrapped thread. The first fabric also comprises first filamentary weft elements consisting of a multifilament strand made of PET having a count equal to 170 tex. This assembly also comprises a second fabric comprising second filamentary warp elements and second filamentary weft elements, each of these elements consisting of a multifilament strand made of PET having a count equal to 170 tex, as well as a load-bearing structure consisting of filamentary elements made of nylon 6,6 with a count of 47 tex coated with a crosslinked adhesive composition of RFL adhesive, these load-bearing filamentary elements exhibiting a thermal contraction, measured at 185° C. after 2 min, of 9%. The filamentary elements of the load-bearing structure have been coated, prior to their incorporation into the assembly according to the invention, using a bonding treatment comprising:
a) a so-called bonding step of bringing the load-bearing filamentary element into contact with an adhesive composition of the RFL adhesive type, consisting of an aqueous composition (approximately 81% by weight of water) based on resorcinol (approximately 2%), formalin (about 1%) and a rubber latex (about 16% NR, SBR and VP-SBR rubbers), and
b) a so-called adhesive drying heat treatment step at a temperature of 190° C. for a period of 2 min,
   the load-bearing filamentary elements of the load-bearing structure being maintained under a tension of 0.4 daN during the bonding treatment.

The two assemblies are then subjected to the same bonding treatment, aimed at allowing their incorporation into a rubber article. To do this, each of these assemblies is coated with a layer of adhesion primer and a layer of adhesive composition. To do this, each of these assemblies is immersed in a first aqueous bath (about 94% water) based on epoxy resin (polyglycerol polyglycidyl ether, about 1%) and isocyanate compound (blocked caprolactam, about 5%). The layer of adhesion primer is then coated with the layer of adhesive composition, here an RFL adhesive (approximately 81% by weight of water) based on resorcinol (approximately 2%), formalin (approximately 1%) and a rubber latex (about 16% NR, SBR and VP-SBR rubbers).

The layers of primer and of adhesion composition are then dried, for example in a drying oven at 140° C. for 30 s. The assemblies are then heat treated so as to crosslink the layers of primer and of adhesion composition by passing the coated assemblies through a treatment oven at 240° C. for 30 s.

The thermal contraction of the load-bearing filamentary elements of each of the assemblies is measured at the end of these operations. The load-bearing elements of the first assembly exhibit a thermal contraction, measured at 185° C. after 2 min, of 0.1%, while the load-bearing elements of the second assembly exhibit a thermal contraction, measured at 185° C. after 2 min, of 5%. The implementation of the assembly according to the invention in a rubber article, in particular a pneumatic tyre, is therefore greatly facilitated because small shifts during its incorporation can be compensated for during the phase of curing (or crosslinking) the rubber article or pneumatic tyre. In addition, due to the homogeneous tension in the load-bearing filamentary elements which will be obtained at the end of the curing of the rubber article or of the pneumatic tyre, the expected operation of the assembly according to the invention will be obtained.

1.-15. (canceled)

16. An assembly comprising:
a first fabric, having a longitudinal edge extending in a first direction (G1);
a second fabric, comprising a longitudinal edge extending in a second direction (G2), the first direction (G1) and the second direction (G2) being substantially parallel; and
a load-bearing structure comprising load-bearing filamentary elements made of heat-shrinkable textile material connecting the first fabric to the second fabric, each load-bearing filamentary element comprising at least one load-bearing filamentary portion extending between the first and the second fabric,
wherein the load-bearing filamentary elements exhibit a thermal contraction CT, measured after 2 min at 185° C., greater than or equal to 5%.

17. The assembly according to claim 16, wherein each load-bearing filamentary element exhibits a thermal contraction CT, measured after 2 min at 185° C., strictly greater than 5%.

18. The assembly according to claim 16, wherein the load-bearing filamentary elements are made of a polyamide material.

19. The assembly according to claim 16, wherein the load-bearing filamentary elements comprise at least one multifilament strand comprising several monofilaments.

20. The assembly according to claim 16, wherein the load-bearing filamentary elements consist of a single monofilament.

21. The assembly according to claim 16, wherein each load-bearing filamentary element has a count in the range from 8 Tex to 210 Tex.

22. The assembly according to claim 16, wherein each load-bearing filamentary element is coated with an adhesive composition.

23. The assembly according to claim 22, wherein, prior to being incorporated into the assembly, each load-bearing filamentary element of the load-bearing structure is subjected to a bonding treatment comprising at least:
(a) an adhesive-coating step of bringing the load-bearing filamentary element into contact with an adhesive composition; and
(b) an adhesive-drying heat treatment step at a temperature ranging from 100 to 230° C. for a period ranging from 30 to 300 s,
wherein the load-bearing filamentary element is maintained under a tension of between 0.2 and 4.0 daN during the bonding treatment.

24. The assembly according to claim 16, wherein the first fabric comprises first warp filamentary elements, substantially parallel to each other and extending in a first warp direction (C1), substantially parallel to the first direction (G1), and
wherein, for any elongation of the first fabric in the first direction (G1) less than or equal to 2×π×H/L there are first warp filamentary elements that are unbroken, with 0<H≤K×H0, H0 representing in meters a mean straight-line distance between an internal face of the first fabric and an internal face of the second fabric when each load-bearing filamentary portion is at rest, L representing in meters a length at rest of the first fabric in the first direction (G1) and K=1.3.

25. An impregnated assembly comprising the assembly according to claim 16, the first fabric being impregnated at least in part with a first polymeric composition, and the second fabric being impregnated at least in part with a second polymeric composition.

26. A rubber article comprising the assembly according to claim 16.

27. A tire comprising the assembly according to claim 16.

28. The tire according to claim 27, the tire comprising a crown having two axial ends each extended, radially inward, by a sidewall then by a bead intended to come into contact with a rim, the assembly consisting of the crown, the two sidewalls and the two beads delimiting a toric interior cavity and at least one bead,
wherein the assembly is intended to react at least part of the nominal load Z applied to the tire mounted on its rim and inflated to its nominal pressure P, the first fabric being fixed to the radially inner part of the crown and the second fabric at least partially delimiting the radially inner part of the toric cavity, the load-bearing structure extending continuously in the toric interior cavity, so that, when the tire is subjected to a nominal load Z, the load-bearing filamentary elements, connected to a portion of tire in contact with the ground, are subjected to buckling in compression and at least a part of the load-bearing filamentary elements, connected to the portion of tire not in contact with the ground, are in tension.

29. The tire according to claim 28, wherein the toric cavity is partially delimited in its radially inner part by at least one second fabric of the assembly.

30. The tire according to claim 29, wherein the at least one bead extends axially inwards by a cantilevered flexible base comprising a free end, the flexible base comprising an anchoring portion for anchoring to the at least one bead and a rigid main-span portion, extending axially inward from the anchoring portion to the free end, and
wherein the second fabric is fixed to the flexible base.
